(19) United States
(12) Patent Application Publication
(10) Pub. No.: US 2004/0007829 A1
(43) Pub. Date: Jan. 15, 2004

(54) Downhole seal assembly and method for use of same

(76) Inventor: Colby M. Ross, Carrollton, TX (US)

Correspondence Address: LAWRENCE R. YOUST, Danamraj & Youst, P.C., Suite 1200, LB 15, 12900 Preston Road, Dallas, TX, 75203-1328, US

(21) Appl. No.: 10/460,020

(22) Filed: Jun. 11, 2003

Related U.S. Application Data
(63) Continuation-in-part of application No. 09/949,372, filed on Sep. 7, 2001.

(51) Int. Cl. F16L 17/025

(52) U.S. Cl. 277/626

(57) ABSTRACT

A downhole seal assembly (70) and method for controlling the flow of fluids in a wellbore (72) are disclosed. The seal assembly (70) includes a tubular member (78) that is positionable within the wellbore (72). A seal element (90) is disposed externally around the tubular member (78). The seal element (90) has a substantially annular shaped body of deformable material such that the seal element (90) is radially expandable into sealing engagement with the wellbore (72) downhole. The body has a passageway (102) extending therethrough, which provides a communication path that bypasses the sealing engagement between the seal element (90) and the wellbore (72).

### CROSS-REFERENCE TO RELATED PATENT APPLICATIONS

This application is a continuation-in-part application of co-pending application Ser. No. 09/949,372, filed Sep. 7, 2001 in the name of Colby M. Ross.

### TECHNICAL FIELD OF THE INVENTION

This invention relates, in general, to downhole sealing devices for sealing the annulus formed between two substantially concentric cylindrical surfaces and, in particular, to a downhole seal assembly and method for creating a fluid seal between a production tubing and a well casing while providing a passageway therethrough for a conduit.

### BACKGROUND OF THE INVENTION

Without limiting the scope of the present invention, its background will be described with reference to producing fluid from a subterranean formation, as an example.

After drilling each of the sections of a subterranean wellbore, individual lengths of relatively large diameter metal tubulars are typically secured together to form a casing string that is positioned within each section of the wellbore. This casing string is used to increase the integrity of the wellbore by preventing the wall of the hole from caving in. In addition, the casing string prevents movement of fluids from one formation to another formation.

Conventionally, each section of the casing string is cemented within the wellbore before the next section of the wellbore is drilled. Accordingly, each subsequent section of the wellbore must have a diameter that is less than the previous section. Typically, each of the casing strings is hung from a casinghead near the surface. Alternatively, some of the casing strings may be in the form of liner strings that extend from near the setting depth of the previous section of casing. In this case, the liner string will be suspended from the previous section of casing on a liner hanger.

Once this well construction process is finished, the completion process may begin. For example, the completion process may include creating hydraulic openings or perforations through the production casing string, the cement and a short distance into the desired formation or formations so that production fluids may enter the interior of the wellbore. In addition, the completion process may involve formation stimulation to enhance production, gravel packing to prevent sand production and the like. The completion process also includes installing a production tubing string within the well that extends from the surface to the production interval or intervals.

Unlike the casing string that forms a part of the wellbore itself, the production tubing string is used to produce the well by providing the conduit for formation fluids to travel from the formation depth to the surface. In addition, tools within the tubing string provide for the control of the fluids being produced from the formation. For example, the production tubing string typically includes one or more seal assemblies. For example, the seal assemblies may be installed above and below a production interval to isolate the production from that interval. Once the seal assemblies are properly positioned, the seal assemblies are actuated to create a sealing and gripping relationship with the walls of the adjacent casing or liner.

To achieve the gripping relationship, typical seal assemblies are equipped with anchor slips that have opposed camming surfaces that cooperate with complementary opposed wedging surfaces. The anchor slips are radially extendable into gripping engagement against the well casing bore in response to relative axial movement of the wedging surfaces. To achieve the sealing relationship, typical seal assemblies carry annular seal elements that are expandable radially into sealing engagement against the bore of the well casing in response to an axial compression force.

In order to improve the efficiency of producing fluids from the subterranean formation traverse by the wellbore, it is quite common to utilize a variety of control lines extending from the surface to downhole equipment installed within the well. The control lines allow for numerous functions to be performed, such as operating an actuator, monitoring well conditions, communicating data and the like. At times, the downhole equipment that require communication with the control lines are located downhole of one or more of the seal assemblies.

Typically, such control lines may be run on the exterior of the tubing string. It has been found, however, that control lines run across the exterior of a seal assembly may prevent proper operation of the seal assembly. In addition, as the seal assemblies are typically larger in diameter than the tubing string, this dimensional increase due to the external lines further restricts passage of the tubing string through a given wellbore and exposes the external lines to damage while running the tubing string.

Alternatively, control lines may be run in the interior of the seal assemblies. It has been found, however, that routing the lines to the interior restricts fluid flow and equipment passage through the seal assemblies. Furthermore, the lines are exposed to erosion due to fluid flow through the seal assemblies and are exposed to damage when equipment is run through the seal assemblies. As another alternative, control lines may be run through the seal assemblies in a region to the interior of the seal element. It has been found, however, that routing the lines through the seal assemblies to the interior of the seal element increases the complexity of the seal assemblies.

Therefore, a need has arisen for a seal assembly and a method of extending lines through a seal assembly that provide for the protection of the lines during conveyance of a tubing string into a well and during production of the well. A need has also arisen for such a seal assembly and a method of extending lines through a seal assembly wherein the lines do not restrict the conveyance of the tubing string in the well and do not restrict passage of equipment through the seal assemblies.

### SUMMARY OF THE INVENTION

The present invention disclosed herein comprises a downhole seal assembly and method for controlling the flow of fluids in a wellbore. The seal assembly of the present invention provides for the protection of conduits during conveyance of a tubing string into a well and during production of the well. Moreover, by employing the seal assembly of the present invention, the conduits do not restrict the conveyance of the tubing string into the well and do not restrict passage of equipment through the seal assembly. The seal assembly of the present invention achieves these results by including a passageway through the seal element that accepts a conduit which allows for communication therethrough.

In one aspect, the present invention is directed to a seal assembly for controlling the flow of fluids in a wellbore. The seal assembly includes a tubular member that is positioned within the wellbore. The tubular member may be an expandable tubular member or may include a prop sleeve. A seal element is disposed externally around the tubular member and includes a substantially annular shaped body of deformable material that is radially expandable into a sealing engagement with the wellbore downhole. The body includes a first end and a second end having a passageway extending therebetween to allow communication through the seal element. In one embodiment, a conduit may be positioned within the passageway. The conduit may be slidably received within the passageway or may be fixed to the first end of the body, the second end of the body or both.

The body of the seal assembly may comprise a yieldable material such as a material selected from the group consisting of metals, plastics, elastomers or the like. In one embodiment, the seal element may include one or more axially extending slots formed in a surface of the body of the seal element. The slots may be positioned in a staggered relationship. The slots may comprise slits in an unexpanded configuration and a diamond shape in an expanded configuration.

In one embodiment, the passageway through the body of the seal element may intersect one or more of the slots such that a conduit positioned within the passageway remains in a substantially axial orientation after expansion of the seal element. In another embodiment, the passageway may not intersect any of the slots such that a conduit positioned within the passageway may be deformed as the seal element is expanded.

The conduit passing through the passageway of the seal element may be of any type, such as control lines, I-wire lines, power lines, signal lines, fiber optic lines, hydraulic lines or the like. In one embodiment, the seal assembly may include fittings on the ends of the conduit for coupling the conduit to exterior conduits.

In another aspect, the present invention is directed to a seal element for providing a seal between a tubular member and a wellbore which may be cased. The seal element includes a substantially annular shaped body of deformable material that is radially expandable into sealing engagement with the wellbore downhole. A passageway extends between the first and second ends of the seal element.

In yet another aspect, the present invention is directed to a method for operating a seal assembly that includes the steps of disposing the seal assembly within a wellbore, radially expanding the seal element such that the seal element sealingly engages the wellbore and communicating through the seal element via the passageway.

In a further aspect, the present invention is directed to a method for treating an interval of a wellbore that includes the steps of isolating the interval, locating a seal assembly positioned within a tubular string within the wellbore between a first region and a second region of the interval, injecting a treatment fluid into the interval and radially expanding a seal element of the seal assembly into sealing engagement with the wellbore, thereby isolating the first region from the second region.

In yet a further aspect, the present invention is directed to a completion system that is positioned within a wellbore that includes a tubular string extending substantially from the surface to a downhole location. A seal assembly is positioned within the tubular string. The seal assembly has a tubular member and a seal element disposed externally around the tubular member that is radially expandable into sealing engagement with the wellbore downhole. The seal element has a substantially annular shaped body of deformable material, which has a first end and a second end. A passageway extends between the first and second ends. A conduit that extends substantially from the surface passes through the passageway of the seal element and provides communication between a tool positioned within the tubular string downhole of the seal assembly and the surface.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic illustration of an offshore oil and gas platform during a treatment process having a pair of downhole seal assemblies in accordance with the present invention;

FIG. 2 is a half sectional view depicting a seal assembly of the present invention positioned within a wellbore prior to sealing;

FIG. 3 is a half sectional view illustrating the seal assembly of FIG. 2 in a sealing position within the wellbore;

FIG. 4 is a cross sectional view illustrating the seal assembly of FIGS. 2 and 3 in the sealing position within the wellbore;

FIG. 5 is a cross sectional view illustrating a seal assembly of the present invention having multiple conduits positioned within multiple passageways of the seal assembly;

FIG. 6 is a front plan view depicting a seal element having a conduit running therethrough in accordance with the present invention prior to sealing;

FIG. 7 is a front plan view depicting the seal element of FIG. 6 in a sealing position;

FIG. 8 is a front plan view depicting another embodiment of a seal element having a conduit running therethrough in accordance with the present invention prior to sealing;

FIG. 9 is a front plan view illustrating the embodiment of a seal element of FIG. 8 having a conduit running therethrough in a sealing position;

FIG. 10 is a further embodiment of a seal element having a conduit running therethrough in accordance with the present invention in a sealing position;

FIG. 11 is a another embodiment of a seal element having a passageway therethrough in accordance with the present invention in a sealing position;

FIG. 12 is a half sectional view depicting the first step of a treatment of a wellbore employing the seal assemblies of the present invention;

FIG. 13 is a half sectional view depicting a second step of the treatment of the wellbore employing the seal assemblies of the present invention; and

FIG. 14 is a half sectional view depicting a third step of the treatment of the wellbore employing the seal assemblies of the present invention.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

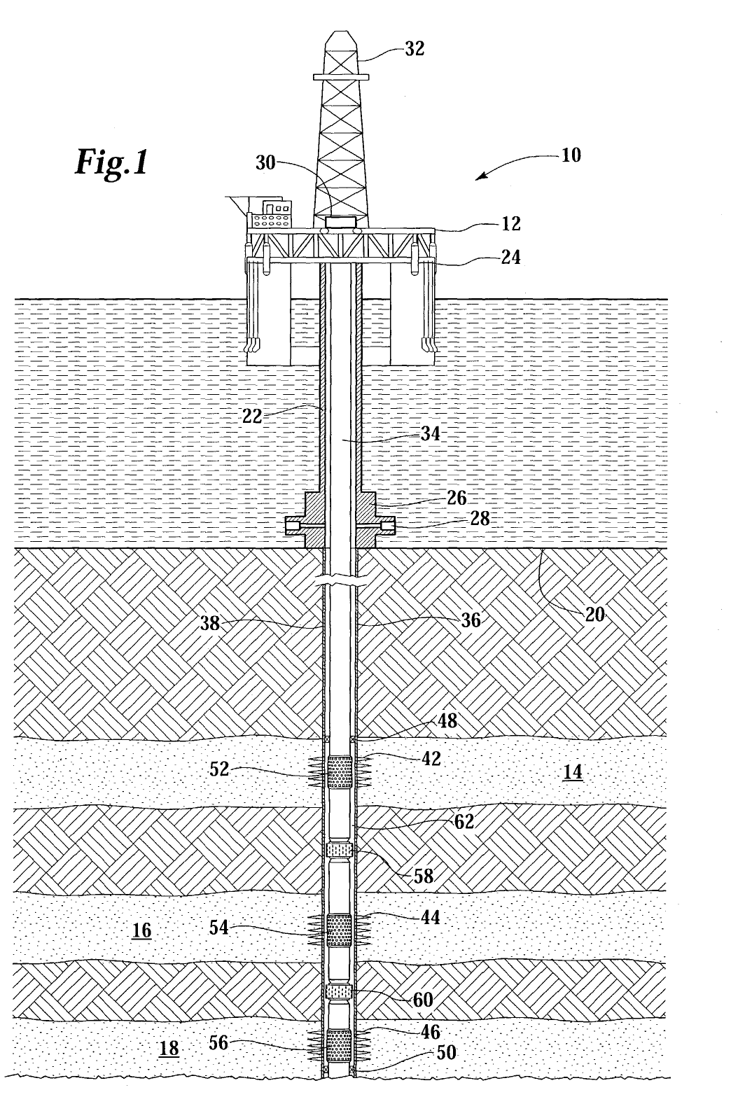

Referring initially to FIG. 1, an offshore oil and gas platform installing completion equipment that includes a pair of seal assemblies for controlling the flow of fluids is schematically illustrated and generally designated 10. A semi-submersible platform 12 is centered over submerged oil and gas formations 14, 16, 18 located below sea floor 20. A subsea conduit 22 extends from deck 24 of platform 12 to wellhead installation 26 including subsea blowout preventers 28. Platform 12 has a hoisting apparatus 30 and a derrick 32 for raising and lowering pipe strings such as work string 34.

A wellbore 36 extends through the various earth strata including formations 14, 16, 18. A casing 38 is cemented within wellbore 36. Perforations 42, 44, 46 provide fluid communication paths from formations 14, 16 and 18, respectively, to the interior of wellbore 36. Work string 34 includes various tools including packers 48, 50 which isolate a multizone production interval spanned by formations 14, 16 and 18. Screen assemblies 52, 54, 56 are positioned adjacent to formations 14, 16, 18, respectively, for filtering the fluids produced therefrom. Seal assembly 58 of the present invention is positioned between formations 14, 16 to control the flow of fluids in wellbore 36. Similarly, seal assembly 60 of the present invention is positioned between formations 16, 18 to control the flow of fluids. Once positioned and expanded into a sealing position, each seal assembly 58, 60 of the present invention blocks the flow of fluids through annulus 62 while providing a passageway that is positioned therethrough and operable to accept a conduit as will be explained in greater detail hereinbelow.

Even though FIG. 1 depicts a vertical well, it should be noted by one skilled in the art that the seal assemblies for controlling the flow of fluids in a wellbore of the present invention are equally well-suited for use in deviated wells, inclined wells or horizontal wells. Also, even though FIG. 1 depicts an offshore operation, it should be noted by one skilled in the art that the seal assembly of the present invention is equally well-suited for use in onshore operations.

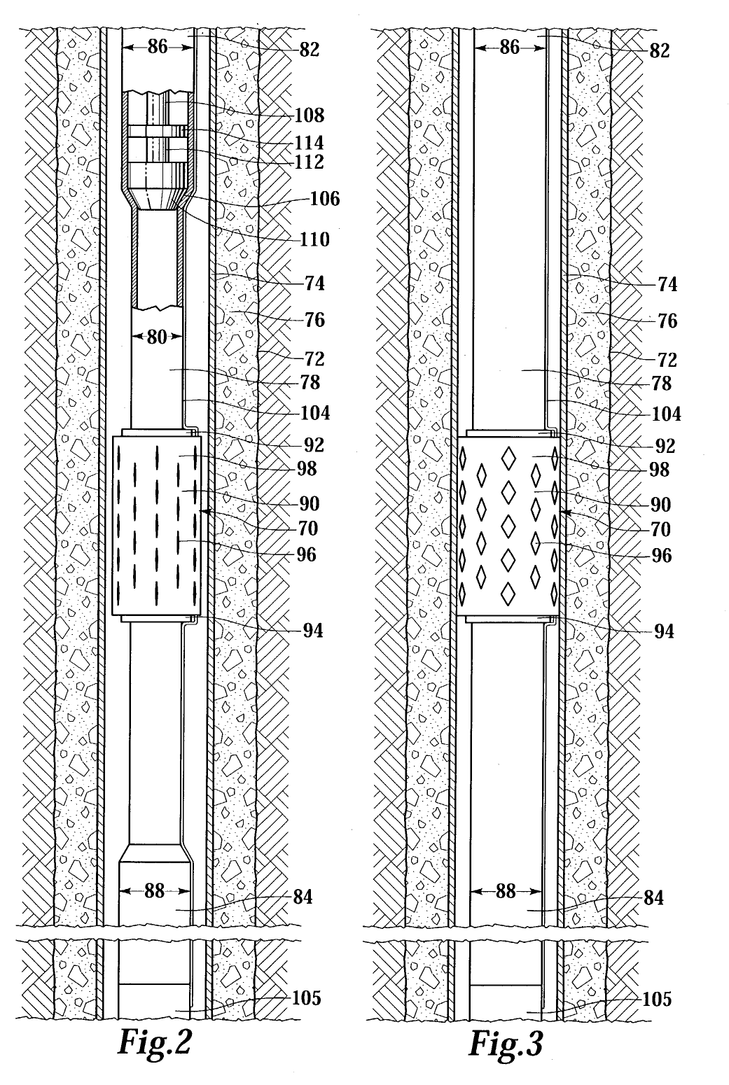

FIG. 2 depicts a seal assembly of the present invention that is positioned within a wellbore 72 and is generally designated 70. Wellbore 72 includes a casing 74 that is cemented within wellbore 72 by cement 76. Seal assembly 70 includes a tubular member 78 having a reduced diameter 80 coupled between tubular members 82, 84. Tubular members 82, 84 have diameters 86, 88, respectively, that are greater than reduced diameter 80 of tubular member 78.

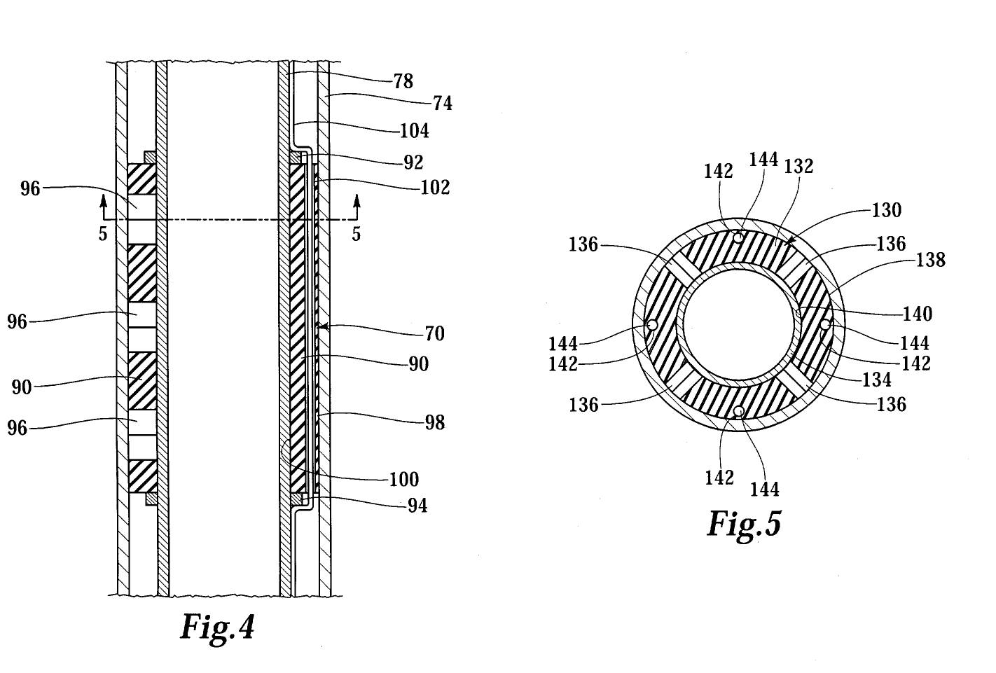

Seal assembly 70 has a seal element 90 that is positioned about a reduced diameter portion of tubular member 78 as will be explained in more detail hereinbelow. Seal element 90 is held in place by annular coupling members 92, 94 which, for example, may be welds, threaded couplings or the like. Seal element 90 has an annular shaped body of a deformable material of a size and shape that allows seal assembly 70 to be run into casing 74 and then fill the annulus between tubular member 78 and casing 74 when seal element 90 is in the sealing position in response to the outward radial movement of the reduced diameter portion of tubular member 78. Preferably, seal element 90 comprises a yieldable material manufactured from metal, plastics, elastomers or the like. In particular, stainless steel, alloy steels, carbon steels, lead based alloys, copper alloys, zinc alloys, plastics, rytons, filled Teflon peek, nitrites, Viton brand fluoroelastomers, Fluorel brand fully-saturated fluorinated polymers, rubber or combinations thereof may be employed, for example, in the construction of seal element 90. By allowing the use of durable seal materials, seal element 90 of the present invention provides a retrievable seal assembly which maintains a reliable seal under high temperature and high pressure conditions for long service periods. Even though seal element 90 is depicted in FIG. 4 as having a smooth outer surface 98 and inner surface 100, it should be understood by those skilled in the art that the surfaces of seal element 90 could alternatively be dimpled, ridged, ringed, waffled, knurled or otherwise irregular or scuffed up.

As illustrated, seal element 90 includes slots 96 which comprise slits or cuts that extend through seal element 90 from an outer surface 98 to an inner surface 100, as best seen in FIG. 4. Slots 96 are arranged in a staggered pattern of spaced axially extending rows, with slots 96 in adjacent rows axially overlapping. In the unexpanded or run condition of FIG. 2, slots 96 are axially extending in that they span a portion of seal element 90 in the axial direction. It should be noted that at a given expansion ratio, slots 96 reduce the hoop stress in seal element 90 allowing the use of stiffer deformable materials within seal element 90.

Although, slots 96 are depicted as extending parallel to the axis of seal element 90, it should be appreciated that slots 96 may span any portion of seal element 90 in any direction. For example, slots 96 could be arranged at an angle from zero to ninety degrees from the illustrated position to extend either circumferentially, axially or both. In addition, slots 96 need not be straight or planar and could be curved or even spiral around seal element 90.

Even though a particular shape has been depicted for slots 96, alternately shaped slots could alternatively be used and are considered within the scope of the present invention, such alternate shapes including, but not limited to, circular slots, oval or oblong slots, rectangular slots, square slots, diamond slots, slit shape with circular shaped end portions slots, irregular shaped slots, triangular shaped slots and the like.

Slots 96 may extend through seal element 90 or may only partially extend through seal element 90. For example, slots 96 may extend from outer surface 98 to inner surface 100 as illustrated in FIG. 4. Alternatively, slots 96 may from the outer surface inwardly or from the inner surface outwardly but not extend completely through the body of seal element 90. As yet another alternative, some of the slots could extend from the outer surface partially inwardly with other of the slots extending from the inner surface partially outwardly. In those embodiments wherein the slots do not extend entirely through the seal element, during expansion of the seal element, the seal element may be allowed to fracture such that the slots will extend entirely through the seal element after expansion. In addition, slots could be formed from one end of seal element 90 to just short of the opposite end. In this embodiment, adjacent slots could intersect opposing ends of seal element 90.

Seal element 90 may comprises a slotted annular metal structure coated with or surrounded by resilient or deformable material. The metal structure may be cylindrical or may have an axially or radially waved or corrugated structure that could be used and coated with resilient or deformable material that has either a cylindrical or corrugated outer surface. In embodiments having a resilient or deformable material coating positioned thereon, it is envisioned that the resilient coating could be as little as a few millimeters thick and depending on its thickness either slotted or unslotted. Also it is envisioned that the coating could be present on only one side of the metal structure.

A passageway 102, as best seen in FIG. 4, traverses the interior of seal element 90 and provides passage for a conduit 104 to pass through seal element 90 when seal element 90 is both in the running position and the sealing position. As illustrated, conduit 104 traverses the outside of tubular member 82, the outside of tubular member 78, the inside of seal element 90, the outside of tubular member 78 again and the outside of tubular member 84. In the illustrated embodiment, conduit 104 extends to a downhole tool 105, such as a sliding sleeve valve, downhole choke or other desired tool, and provides power, signals, control or other function to downhole tool 105. In this manner, the passageway 102 of the seal assembly 70 of the present invention provides passage for conduit 104 such that conduit 104 does not interfere with the sealing engagement of seal assembly 70.

An expander member 106 is positioned in tubular member 78 by retrievable conduit 108 and is operable to deform and radially expand tubular member 78 and seal element 90. Expander member 106 includes a tapered cone section 110, a piston 112 and an anchor section 114. In operation, a downward force is applied on expander member 106 by applying the weight of retrievable conduit 108 on expander member 106. This downward force operates to stroke piston 112 to its compressed position. Once piston 106 completes its downward stroke, fluid is pumped into expander member 106 which sets anchor section 114 creating a gripping force against the interior of tubular member 78. As more fluid is pumped down retrievable conduit 108 into the interior of expander member 106, the fluid pressure urges tapered cone section 110 downwardly such that tapered cone section 110 places a radially outward force against the wall of tubular member 78 causing tubular member 78 to radially deform such that reduced diameter 80 of tubular member 78 approximates diameter 86 of tubular member 82. This process continues in step wise fashion wherein each stroke of expander member 106 expands a section of tubular member 78. When the section of tubular member 78 within seal element 90 is radially expanded, seal element 90 expands into sealing engagement with casing 74 of wellbore 72. After tubular member 78 and seal element 90 have been expanded, retrievable conduit 108 and expander member 106 may be retrieved to the surface.

It should be appreciated that although a specific type of expander member, i.e., a hydraulically powered expander member has been presented, the method of expanding the seal element of the present invention may employ any type of technique that is known in the art or subsequently discovered. For example, when yieldable materials are used in seal element 90, axially movable ramps, wedges, expanders, prop sleeves or the like may be used to expand seal element 90 into a sealing position. For example, seal element 90 may be expanded from the running position and the sealing position by sliding seal element 90 relative to a prop sleeve using either a mechanical running tool or by hydraulic means. In this case, the prop sleeve is integrally formed with the body the tubular member about which seal element 90 is positioned. The tubular member has a prop surface that supports seal element 90 in the sealing position and running surface that supports seal element 90 in the running position. The prop surface has an outer diameter, similar to outer diameter 86, that is greater than the outer diameter of the running surface, such as outer diameter 80. To expand seal element 90 from the running position to the sealing position, the prop surface is injected under seal element 90. This is preferably achieved by sliding seal element 90 over a ramp that has an external surface which slopes between the prop surface and the running surface. The slope angle of the ramp is selected based upon the materials of seal element 90 and the required expansion of seal element 90.

In some instances due to the expansion of slots 96, the deformation of seal element 90 may exceed the elastic stress limits of the seal material of seal element 90 resulting in permanent deformation of seal element 90. Seal element 90 and its material should be selected so that even though the elastic limit is exceeded the ultimate strength is not. Even if seal element 90 is permanently deformation, seal element 90 is readily retrieved from the wellbore with the assistance of a retrieving tool that reduces the outer diameter of the tubular member supporting seal element 90 and by pulling the tubular member uphole, thereby relaxing seal element 90 and freeing seal element 90 for retrieval to the surface.

FIG. 3 depicts seal assembly 70 of the present invention in a sealing position within wellbore 72 after seal element 90 has been expanded into sealing engagement with casing 74. As illustrated, expander member 106 of FIG. 2 has passed through tubular member 78 and seal element 90. Accordingly, seal element 90 has expanded into a sealing position wherein seal element 90 sealingly engages casing 74. In the sealing position, in addition to providing a fluid seal between tubular member 78 and casing 74, seal assembly 70 may be used to support additional tubing or completion equipment in much the same manner as a conventional seal assembly. In the expanded position, seal element 90 has become axially shorter and radially enlarged. Moreover, slots 96 of seal element are distorted and deformed from the slit shape of FIG. 2 into diamond shapes. It should be appreciated, however, that the shape of the deformed slots 96 will be depended on a variety of factors including the original slot shape and the amount of expansion of seal element 90.

After expansion of seal assembly 70 into sealing position, conduit 104 continues to traverse the outside of tubular member 82, the outside of tubular member 78, the inside of seal element 90, the outside of tubular member 78 again and the outside of tubular member 84. In particular, with reference to FIG. 4, conduit 104 is illustrated entering seal element 90 and traveling through passageway 102 of seal element 90. Accordingly, by providing for the use of more durable seal materials, the seal element of the present invention provides a retrievable packer which maintains a passageway for a conduit such that the conduit does not interfere with the seal formed by the seal element with the casing of the wellbore.

FIG. 5 depicts a seal assembly 130 of the present invention having multiple conduits positioned therein. Seal assembly 130 includes a seal element 132 positioned about the exterior of a tubular member 134. Slots 136 comprise diamond shapes in the expanded configuration which extend through seal element 132 from an outer surface 138 to an inner surface 140. Passageways 142 traverse seal element 132 and allow conduits 144 to pass therethrough. For example, conduits 144 may include control line conduits, I-wire line conduits, power line conduits, signal line conduits and the like which may be used for controlling the operational states of, supplying power to or otherwise communicating with tools located downhole of seal element 132 from the surface. Although four passageways 142 having four conduits 144 are illustrated, it should be appreciated that more or less passageways and conduits are within the teachings of the present invention. Moreover, the passageways may include other types of conduits such as hydraulic line conduits, fiber optic line conduits or conduits that include sensors, for example.

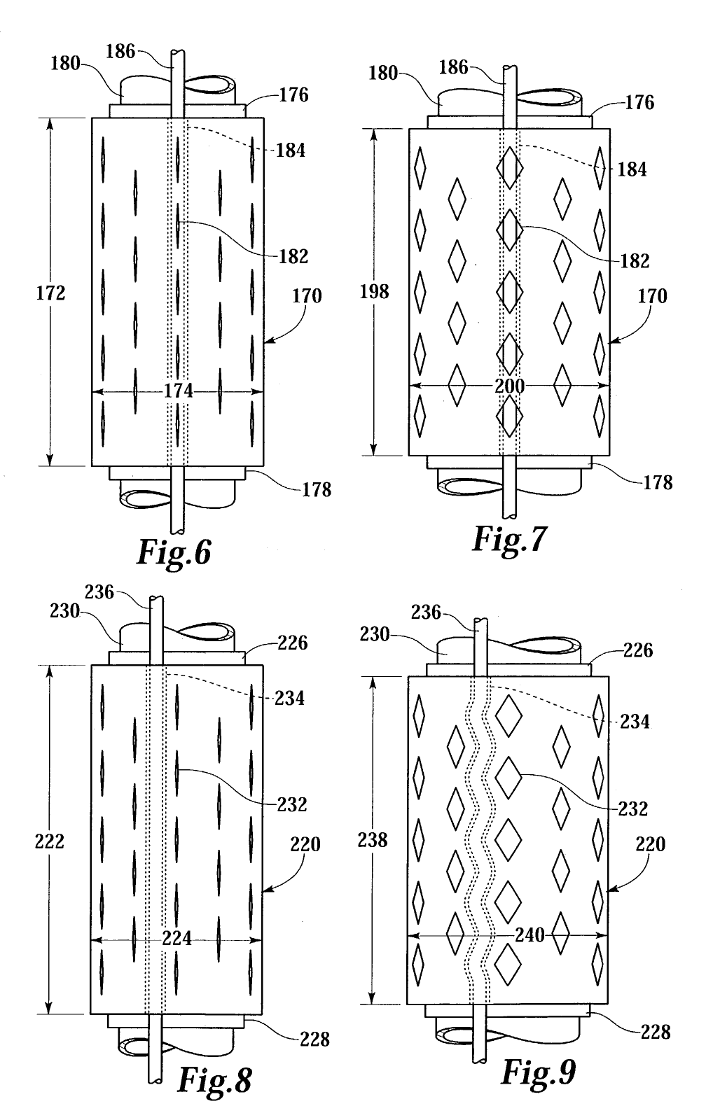

FIG. 6 depicts a seal element 170 having an axial length 172 and a diameter 174 which is coupled by annular coupling members 176, 178 to an expandable tubular 180. Slots 182 are positioned in a staggered pattern and extend through seal element 170. A passageway 184 traverses the interior of seal element 170 and intersects certain of slots 182 in order to allow conduit 186 to be positioned substantially in axial alignment with seal element 170. It will be appreciated by those skilled in the art that the construction of passageway 184 depends on the materials that seal element 170 comprises. For example, seal element 170 may be formed from a polymer, such as the aforementioned fluoroelastomer, having a select group of additives to modify the properties of the fluoroelastomer and impart greater thermal resistance. A moveable mold of the seal element may be employed in conjunction with heat and pressure to compression mold the molten fluoroelastomer and additives into the shape of the seal element. Following a uniform cooling, the passageway may be bored into the seal element and the slots may be cut into the seal element. Alternatively, reaction injection molding, extrusion or other suitable technique may be employed to form the seal element of the present invention.

FIG. 7 depicts seal element 170 in a sealing position after the expansion thereof. Upon expansion, the axial length has decreased as indicated by reference numeral 198 and the diameter has increased as indicated by reference numeral 200. As the diameter of seal element 170 increases, slots 182 deform into diamond shapes which reduces the hoop stress on seal element 170 and allows seal element 170 to maintain its structural integrity while radially expanding to achieve a sealing engagement with the wellbore. In this sealing position, passageway 184 remains substantially in axial alignment with seal element 170. Moreover, as illustrated, passageway 184 and conduit 186 remain substantially aligned with slots 182. Preferably, conduit 186 will slide within passageway 184 to allow for the reduction in the length of seal element 170 during radial expansion. Alternatively, conduit 186 could be fixed to either the top or the bottom end of seal element 170 and be free to slide relative to the other end. In either case, conduit 186 is positioned substantially in axial alignment with seal element 170 when seal element 170 is in both the run and expanded positions.

FIG. 8 depicts another embodiment of a seal element 220 having an axial length 222 and a diameter 224 which is coupled by annular coupling members 226, 228 to expandable tubular 230. Seal element 220 includes slots 232 which are positioned in a staggered pattern and extend through seal element 220. A passageway 234 traverses the interior of seal element 220 and receives conduit 236 therethrough. Contrary to the seal element of FIG. 6, passageway 234 is positioned in seal element 220 such that no slots 232 are intersected. Accordingly, conduit 236 does not intersect any slots 232.

FIG. 9 depicts seal element 220 in a sealing position after the expansion of seal element 220. In the sealing position, seal element 220 is deformed by the radial deformation forces such that the axial length decreases as indicated by reference numeral 238, the diameter increases as indicated by reference numeral 246 and slots 242 become diamond shaped. Preferably, conduit 236 is fixed relative to seal element 220 such that as seal element 220 is deformed, conduit 236 is also deformed within passageway 234 to take a non linear shape. Alternatively, conduit 236 could be slidable relative to seal element 220 or be fixed relative to one end of seal element 220 and slidable relative to the other end.

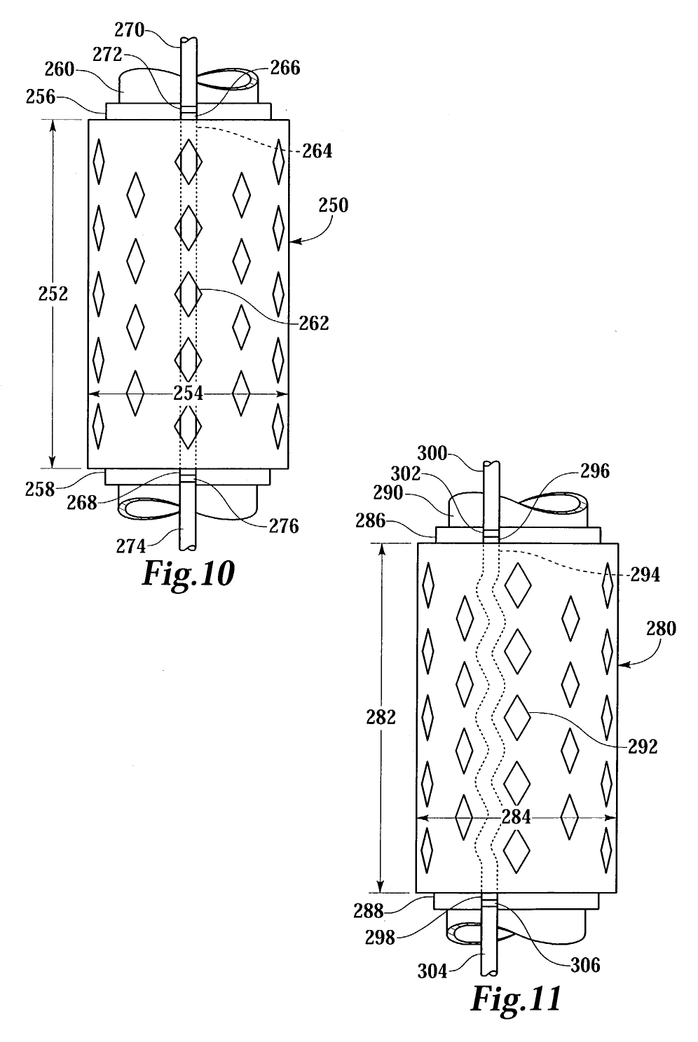

FIG. 10 depicts a further embodiment of a seal element 250 of the present invention in an expanded position having an axial length 252 and a diameter 254. Seal element 250 is coupled by annular couplings 256, 258 to expandable tubular 260. In the illustrated expanded configuration, slots 262 are positioned in a staggered pattern comprising diamond shapes that extend through seal element 250. A conduit 264 traverses the interior of seal element 250 and terminates at fittings 266, 268. Conduit 264 intersects certain slots 262 and is in substantial axial alignment with seal element 250. Fitting 266 provides for coupling to a conduit 270 via a fitting 272. Similarly, a fitting 268 provides for coupling to a conduit 274 via a fitting 276. In operation, conduit 270 may be coupled to conduit 264 by fittings 266, 272 that form a compression fastening, a threaded fastening, or the like. Similarly, conduit 274 is coupled to conduit 264 by fittings 268, 276. In this embodiment, a conduit is not run through the seal element, but rather an exterior conduit is fastened to each end of a conduit prepositioned within the body of the seal element.

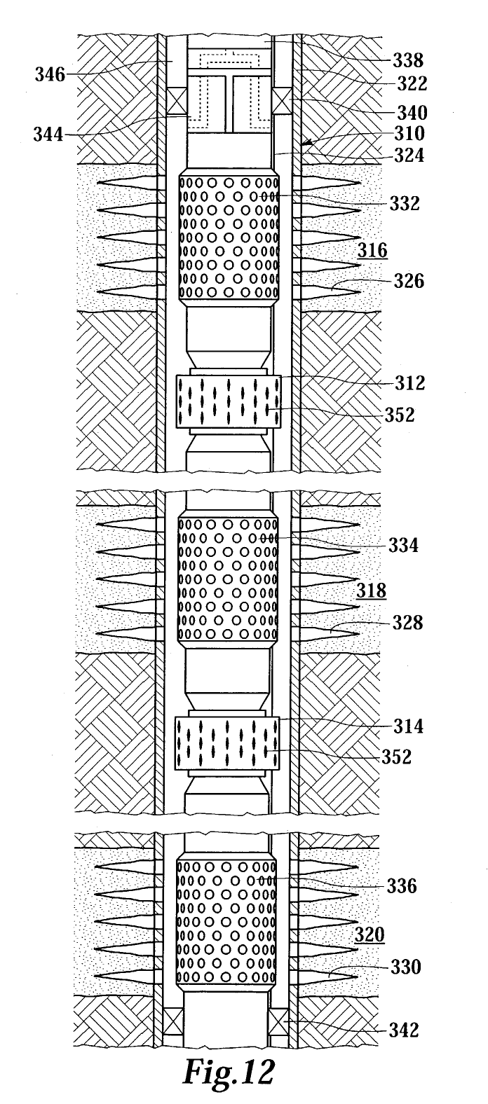

FIG. 11 depicts another embodiment of a seal element 280 of the present invention in an expanded position having an axial length 282 and a diameter 284. Seal element 280 is coupled by annular couplings 286, 288 to expandable tubular 290. In the illustrated expanded configuration, slots 292 are positioned in a staggered pattern comprising diamond shapes that extend through seal element 280. A passageway 294 traverses the interior of seal element 280 and terminates at fittings 296, 298 on either end of seal element 280. Passageway 294 may be formed in seal element 280 by drilling or other suitable material removal technique. As passageway 294 does not intersects any of the slots 292, it is not necessary to have a conduit positioned with passageway 294 in this embodiment. Also, as illustrated, passageway 294 has a non linear shape due to the deformation of seal element 280 during expansion. Fitting 296 provides for coupling to a conduit 300 via a fitting 302. Similarly, a fitting 298 provides for coupling to a conduit 304 via a fitting 306. In operation, communication through seal element 280 is achieved by communicating between conduits 300, 304 via passageway 294.

FIG. 12 illustrates the first step of a treatment process for a wellbore 310 employing seal assemblies 312, 314 of the present invention. A completion process is illustrated wherein wellbore 310 extends through the various earth strata including formations 316, 318, 320. A casing 322 is positioned within wellbore 310. A conduit 324 passes through the depicted interval and through seal assemblies 312, 314 as described above. Perforations 326, 328, 330 provide fluid communication paths from formations 316, 318, 320, respectively, to the interior of wellbore 310. Screen assemblies 332, 334, 336 are positioned on a work string 338.

The gravel packing process will now be described. First, the entire interval adjacent to formations 316, 318, 320 is isolated. A packer 340 seals the upper end of the annular interval and packer 342 seals the lower end of the annular interval. A cross-over assembly 344 is located proximate to screen assembly 332, traversing packer 340 with portions of cross-over assembly 344 on either side of packer 340. When the gravel packing operation commences, the objective is to uniformly and completely fill the interval with gravel. To help achieve this result, a wash pipe (not pictured) is appropriately disposed within screen assemblies 332, 334, 336 extending from cross-over assembly 344 such that return fluid passing through screen assemblies 332, 334, 336, may travel through the wash pipe and cross-over assembly 344 into annulus 346 above packer 340 for return to the surface. Seal assembly 312 of the present invention in its unexpanded configuration is positioned between formations 316, 318 in wellbore 310. Similarly, seal assembly 314 of the present invention in its unexpanded configuration is positioned between formations 318, 320.

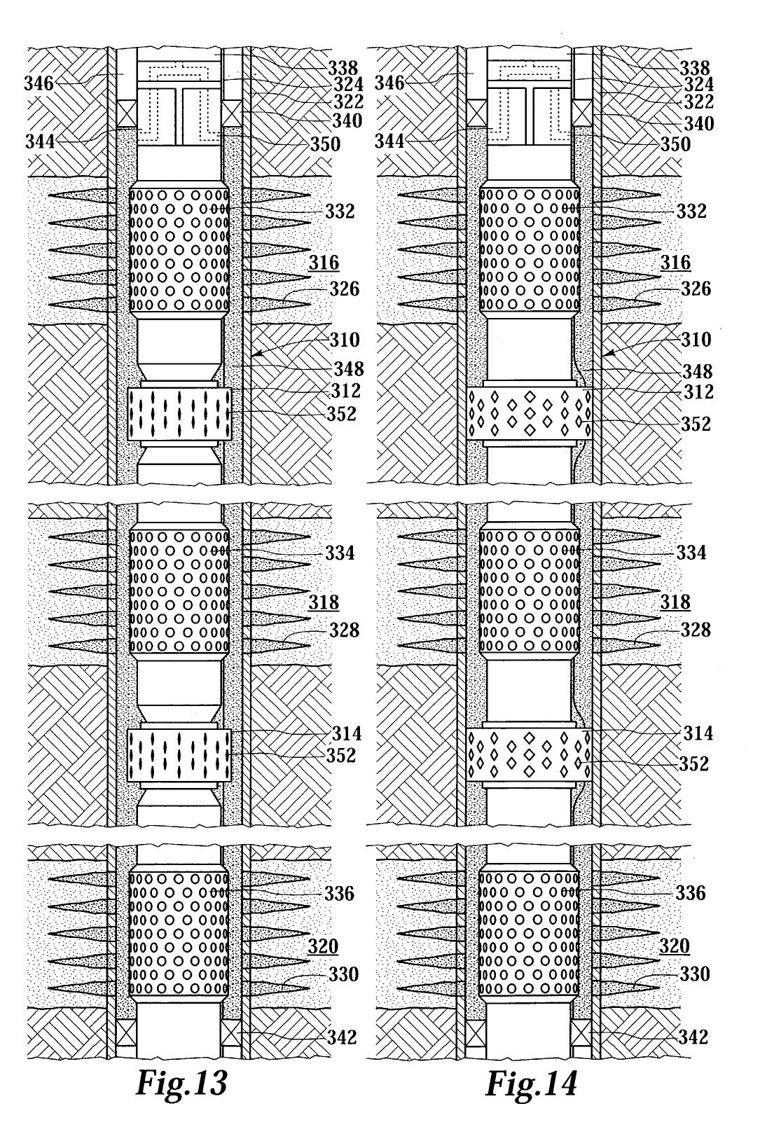

FIG. 13 depicts a second step of the treatment of wellbore 310 employing seal assemblies 312, 314 of the present invention. The fluid slurry containing a particulate material such as sand, gravel, proppants or the like, which will be referred to generally herein as gravel, is pumped down work string 338 into cross-over assembly 344. The fluid slurry containing gravel 348 exits cross-over assembly 344 through cross-over ports 350 and is discharged into the interval between packers 340, 342. As the fluid slurry containing gravel fills the annular interval, gravel 348 drops out of the slurry and builds up from formation 320, filling perforations 330 and an annular region around screen assembly 336 forming a portion of a gravel pack 348. Some of the carrier fluid in the slurry may leak off through perforations 330 into formation 320 while the remainder of the carrier fluid passes through screen assembly 336 that is sized to prevent gravel from flowing therethrough. The fluid flowing back through screen assembly 336, as explained above, enters the wash pipe positioned within screen assembly 336, passes through cross-over assembly 344 and into annulus 346 for return to the surface.

The gravel pack progresses uphole in a similar manner wherein the gravel 348 builds up progressively around screen assemblies 334, 332, filling perforations 328, 326. A portion of the carrier fluid in the slurry leaks off through perforations 328, 326 into formations 318, 316, respectively, while the remainder of the carrier fluid passes through screen assemblies 334, 332, the wash pipe, cross-over assembly 344 and back to the surface.

FIG. 14 illustrates the third step of the treatment of the wellbore employing the seal assemblies of the present invention. As illustrated, the gravel packing treatment process has progressed along the entire interval between packers 340, 342. Once the interval has been completely packed, seal assemblies 312, 314 may be actuated. As previously discussed, each seal assembly 312, 314 includes a yieldable and deformable material having slots 352. As illustrated, seal assemblies 312, 314 are actuated and radially deformed into a sealing engagement with casing 322. Expanded slots 352 provide voids that allow gravel 348 to enter into seal assemblies 312, 314 during expansion. In this manner, each seal assembly 312, 314 may be expanded after the interval has have been treated yet form a fluid tight seal with casing 322. Accordingly, as illustrated, this method allows more than one production zone of a wellbore to be simultaneously treated without the need for isolating each zone prior to treatment.

Although the seal assembly present invention has been described in relation to a gravel packing treatment processes, it should be appreciated by those skilled in the art that the seal assembly of the present invention may work with any type of completion processes. For example, the screen assembly of the present invention may be employed during a formation fracturing and propping treatment operation wherein a hydraulic fracturing fluid is employed to increase the permeability of the production interval adjacent the wellbore. In particular, the fracture fluid is forced into the formation at a flow rate great enough to generated the required pressure to fracture the formation allowing the entrained proppant to enter the fractures and prop the formation structures apart, producing channels which will create highly conductive paths reaching out into the production interval, and thereby increasing the reservoir permeability in the fracture region. Moreover, although FIGS. 12-14 depict three production zones being treated, it should be appreciated more or less production zones may be treated using the seal assembly of the present invention.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A seal assembly for controlling the flow of fluids in a wellbore comprising:
a tubular member positionable within the wellbore; and
a seal element disposed externally around the tubular member, the seal element having a substantially annular shaped body of deformable material, the body having a first end and a second end, the body having a passageway extending between the first and second ends, the seal element radially expandable into sealing engagement with the wellbore downhole.

2. The seal assembly as recited in claim 1 further comprising a conduit positioned within the passageway.

3. The seal assembly as recited in claim 2 wherein the conduit is slidably received in the passageway.

4. The seal assembly as recited in claim 2 wherein the conduit is fixed relative to the first end of the seal element.

5. The seal assembly as recited in claim 2 wherein the conduit is fixed relative to the first and second ends of the seal element.

6. The seal assembly as recited in claim 2 wherein the conduit is selected from the group consisting of control lines, I-wire lines, power lines, signal lines, fiber optic lines and hydraulic lines.

7. The seal assembly as recited in claim 1 wherein the tubular member further comprises an expandable tubular member.

8. The seal assembly as recited in claim 1 wherein the tubular member further comprises a prop sleeve.

9. The seal assembly as recited in claim 1 wherein the seal element includes at least one slot formed in a surface of the body.

10. The seal assembly as recited in claim 9 wherein the passageway intersects the slot.

11. The seal assembly as recited in claim 9 wherein the passageway does not intersect the slot.

12. The seal assembly as recited in claim 1 wherein the body further comprises a material selected from the group consisting of metals, plastics, elastomers, stainless steel, alloy steels, carbon steels, lead based alloys, copper alloys, zinc alloys, plastics, rytons, filled Teflon peek, nitrites, fluoroelastomers, fully-saturated fluorinated polymers, rubbers and combinations thereof.

13. The seal assembly as recited in claim 1 wherein the body further comprises a yieldable material.

14. A seal element for providing a seal between a tubular member and a wellbore, the seal element comprising:
a substantially annular shaped body of deformable material and having a first end and a second end, the body having a passageway extending between the first and second ends, the seal element radially expandable into sealing engagement with the wellbore downhole.

15. The seal element as recited in claim 14 wherein the body includes at least one axially extending slot formed in a surface thereof.

16. The seal element as recited in claim 15 wherein the slot further comprises a slit in an unexpanded configuration of the seal element.

17. The seal element as recited in claim 15 wherein the slot further comprises a diamond shape in an expanded configuration of the seal element.

18. The seal element as recited in claim 15 wherein the passageway intersects the slot.

19. The seal element as recited in claim 15 wherein the passageway does not intersect the slot.

20. The seal assembly as recited in claim 14 further comprising a conduit positioned within the passageway.

21. The seal element as recited in claim 20 wherein the conduit is selected from the group consisting of control lines, I-wire lines, power lines, signal lines, fiber optic lines and hydraulic lines.

22. The seal element as recited in claim 20 further comprising fittings on the ends of the conduit for coupling the conduit to exterior conduits.

23. A method for operating a seal assembly that includes a tubular member having a seal element disposed externally therearound, the seal element having a substantially annular shaped body of deformable material having a first end and a second end, the body having a passageway extending between the first and second ends, the method comprising the steps of:
disposing the seal assembly within a wellbore;
radially expanding the seal element such that the seal element sealingly engages the wellbore; and
communicating through the seal element via the passageway.

24. The method as recited in claim 23 further comprising positioning a conduit within the passageway and communicating through the seal element via the conduit.

25. The method as recited in claim 23 wherein the step of radially expanding the tubular member such that the seal element sealing engages the wellbore further comprises the step of running an expander member through an expandable tubular member.

26. The method as recited in claim 23 wherein the step of radially expanding the tubular member such that the seal element sealing engages the wellbore further comprises the step of shifting a prop sleeve relative to the seal element.

27. The method as recited in claim 23 wherein the step of radially expanding the tubular member such that the seal element sealing engages the wellbore further comprises yieldably deforming the seal element.

28. The method as recited in claim 23 wherein the step of communicating through the seal element via the passageway further comprises communicating fluid through the seal element.

29. The method as recited in claim 23 wherein the step of communicating through the seal element via the passageway further comprises communicating power through the seal element.

30. The method as recited in claim 23 wherein the step of communicating through the seal element via the passageway further comprises communicating signals through the seal element.

31. The method as recited in claim 23 wherein the step of communicating through the seal element via the passageway further comprises communicating optical energy through the seal element.

32. The method as recited in claim 23 wherein the step of communicating through the seal element via the passageway further comprises communicating electrical energy through the seal element.

33. The method as recited in claim 23 wherein the step of communicating through the seal element via the passageway further comprises communicating hydraulic energy through the seal element.

34. A method for treating an interval of a wellbore comprising the steps of:
isolating the interval;
locating a seal assembly positioned within a tubular string within the wellbore between a first region and a second region of the interval;
injecting a treatment fluid into the interval; and
radially expanding a seal element of the seal assembly into sealing engagement with the wellbore, thereby isolating the first region from the second region.

35. The method as recited in claim 34 wherein the step of radially expanding the seal element further comprises the step of running an expander member through the tubular member.

36. The method as recited in claim 34 wherein the step of radially expanding the seal element further comprises the step of shifting a prop sleeve relative to the seal element.

37. The method as recited in claim 34 wherein the step of radially expanding the seal element further comprises yieldably deforming the seal element.

38. The method as recited in claim 34 wherein the step of radially expanding the seal element further comprises circumferentially expanding slots formed in a surface of the seal element.

39. The method as recited in claim 34 wherein the step of injecting a treatment fluid into the interval further comprises forming a gravel pack in the interval.

40. The method as recited in claim 39 wherein the step of radially expanding a seal element of the seal assembly into sealing engagement with the wellbore further comprises receiving portions of the gravel in voids in the seal element.

41. The method as recited in claim 34 further comprising positioning extending a passageway through the seal element and communicating through the seal element via the passageway.

42. The method as recited in claim 41 further comprising positioning a conduit within the passageway extending through the seal element and communicating through the seal element via the conduit

43. The method as recited in claim 41 wherein the step of communicating through the seal element via the passageway further comprises communicating fluid through the seal element.

44. The method as recited in claim 41 wherein the step of communicating through the seal element via the passageway further comprises communicating power through the seal element.

45. The method as recited in claim 41 wherein the step of communicating through the seal element via the passageway further comprises communicating signals through the seal element.

46. The method as recited in claim 41 wherein the step of communicating through the seal element via the passageway further comprises communicating optical energy through the seal element.

47. The method as recited in claim 41 wherein the step of communicating through the seal element via the passageway further comprises communicating electrical energy through the seal element.

48. The method as recited in claim 41 wherein the step of communicating through the seal element via the passageway further comprises communicating hydraulic energy through the seal element.

49. The method as recited in claim 34 wherein the step of isolating the first region from the second region further comprises isolating a first production zone from a second production zone.

50. The method as recited in claim 34 wherein the step of isolating the first region from the second region further comprises isolating two regions of a single production zone.

51. A completion system for positioning within a wellbore comprising:
a tubular string extending substantially from the surface to a downhole location;
a seal assembly positioned within the tubular string, the seal assembly having a tubular member and a seal element disposed externally around the tubular member, the seal element having a substantially annular shaped body of deformable material, the body having a first end and a second end, the body having a passageway extending between the first and second ends, the seal element radially expandable into sealing engagement with the wellbore downhole;
a conduit extending substantially from the surface and passing through the passageway of the seal element; and
a tool positioned downhole of the seal assembly and within the tubular string, the tool in communication with the surface via the conduit.

52. The completion system as recited in claim 51 further comprising a pair of sand control screen assemblies positioned within the tubular string, one of the sand control screen assemblies located uphole of the seal assembly, the other of the sand control screen assemblies located downhole of the seal assembly.
